(19) United States
(12) Patent Application Publication
(10) Pub. No.: US 2024/0240287 A1
(43) Pub. Date: Jul. 18, 2024

(54) ALLOY, POWDER, METHOD AND COMPONENT

(71) Applicant: Siemens Energy Global GmbH & Co. KG, Munich, Bayern (DE)

(72) Inventors: Timo Depka, Bochum (DE); Phillip Draa, Atlanta, GA (US); Birgit Grüger, Dortmund (DE); Anna Kapustina, Düsseldorf (DE); Oliver Lüsebrink, Witten (DE); Kirtan Patel, Charlotte, NC (US); Raymond G. Snider, Orlando, FL (US)

(73) Assignee: Siemens Energy Global GmbH & Co. KG, Munich, Bayern (DE)

(21) Appl. No.: 18/559,043

(22) PCT Filed: Apr. 12, 2022
(86) PCT No.: PCT/EP2022/059721

§ 371 Date: Nov. 4, 2023

(30) Foreign Application Priority Data
May 11, 2021 (DE) 10 2021 204 745.9

(51) Int. Cl. C22C 19/05; B22D 21/02; B22F 1/00; B22F 1/10; B22F 10/28; B33Y 70/00

(52) U.S. Cl. CPC C22C 19/056; B22F 1/09; B22F 1/10; B33Y 70/00; B22D 21/025; B22F 10/28; B22F 2301/15; B22F 2998/10; B22F 2999/00

(57) ABSTRACT

A nickel-based alloy of carbon (C): 0.11%-0.13% chromium (Cr): 9.7%-10.5% cobalt (Co): 10.5%-12.5% molybdenum (Mo): 2.8%-3.2% titanium (Ti): 3.3%-4.3% aluminum (Al): 5.2%-5.8%, Hafnium (Hf): 1.30%-1.50%; boron (B): 013%-014%; zirconium (Zr): 0.015%-0.03%, tantalum (Ta): up to 0.05%, niobium (Nb): up to 0.01%, silicon (Si): up to 0.01%, tungsten (W): up to 0.02%, vanadium (V): up to 0.02% no rhenium (Re) and/or no ruthenium (Ru), nickel, remaining impurities up to 0.1%.

### CROSS REFERENCE TO RELATED APPLICATIONS

This application is the US National Stage of International Application No. PCT/EP2022/059721 filed 12 Apr. 2022, and claims the benefit thereof, which is incorporated by reference herein in its entirety. The International Application claims the benefit of German Application No. DE 10 2021 204 745.9 filed 11 May 2021.

### FIELD OF INVENTION

The invention relates to an alloy, a powder, a production process employing the alloy or the powder, and a component comprising same.

### BACKGROUND OF INVENTION

Nickel-based superalloys are known materials for high-temperature applications as in the case of gas turbines for heat shields in combustion chambers or else for turbine blades in the hot gas pathway.

These superalloys are required at high temperatures to be oxidation-resistant and to have high mechanical strength.

An advantage for boosting the efficiency is to minimize the weight, particularly in the case of rotating components such as turbine blades.

### SUMMARY OF INVENTION

It is an object of the invention to solve the problem stated above. The object is achieved by an alloy, a powder, a process, and a component as claimed.

The invention utilizes an improvement in the chemical composition of nickel-based superalloys in the sense of an improvement in the specific mechanical properties through adaptation of suitable elements, while retaining the capacity for crack-free processing and the productivity.

The invention is described only illustratively below. A description will now be given of the function of the individual elements included in the high-heat-resistant nickel-based alloy for the purpose of performing the above-described invention.

Carbon (C) is added and, in addition to its function as a deoxidizing element, has further functions of combining with titanium (Ti), niobium (Nb) and tantalum (Ta) to form stable MC-type primary carbides in order to suppress the coarsening of austenitic grains during a hot forming operation and to improve the high-temperature lubricity. The desired effect of the carbon (C) is achieved by adding an amount of at least 0.11%, but if added at more than 0.13% it forms the catenary microstructure of the MC-type carbide and causes hot cracks to form, originating from this part, with a consequent reduction in tooling life.

Carbon (C) is added accordingly in an amount of 0.11 wt % to 0.13 wt %, preferably 0.12 wt %.

Chromium (Cr) forms an oxide layer with extremely close adhesion on the surface during heating to high temperatures, and improves the oxidation resistance. Additionally, chromium (Cr) may also improve the hot formability.

For this effect, it must be added in an amount of more than 9.0 wt %, but if added excessively, at more than 11.0 wt %, it causes the precipitation of an a phase, which is accompanied by a reduction in the ductility.

Accordingly, the amount of chromium (Cr) is in a range above 9.7 wt % but not more than 10.5 wt %, preferably up to 10.0 wt %.

Molybdenum (Mo) is an element in the same group as tungsten (W), and replacing some tungsten (W) with molybdenum (Mo) may therefore provide the same function as that of tungsten (W). Since, however, its effect is lower than that of tungsten (W), molybdenum (Mo) is added in a range from 2.8 wt % to 3.2 wt %, more particularly 3.0 wt %.

Aluminum (Al) is an additive element which is key to the formation of a stable γ′ phase after a tempering treatment and which is to be added in an amount of at least 5.0 wt %. Added in excess of 6.0 wt %, however, it causes an increase in the γ′ phase and lowers the hot formability. Accordingly, aluminum (Al) is situated in a range from 5.2 wt % to 5.8 wt %, preferably 5.5 wt %.

Hafnium (Hf) reduces the susceptibility to hot cracking during casting and improves the ductility, particularly in the case of DS materials with columnar grains in transverse direction. Hafnium (Hf) also improves the oxidation resistance. On the other hand, hafnium (Hf) lowers the initial melting temperature and because of its high reactivity may lead to reactions with the mold shell during casting. Hafnium (Hf) is therefore used at a concentration of up to max. 1.5 wt %.

Some of the titanium (Ti) is combined with carbon (C) to form a stable MC-type primary carbide and has a strength-enhancing function for alloys which are not γ′-hardened.

The remaining titanium (Ti) is present in the γ′ phase in the solid solution state, thereby strengthening the γ′ phase, and it serves to improve the high-temperature strength. Titanium (Ti) must therefore be added in an amount of at least 3.6 wt %, but the excessive addition thereof in excess of 4.0 wt % not only lowers the hot formability but also makes the γ′ phase unstable and causes reductions in the strength after long-term use at high temperatures. Titanium (Ti) is therefore preferably also situated in the range up to 3.8 wt %.

Additionally, aluminum (Al), tantalum (Ta) and titanium (Ti) also have an important function of improving the oxidation resistance, and form stable oxide layer systems especially when the elements are combined.

In the same way as titanium (Ti), some of both niobium (Nb) and tantalum (Ta) is combined with carbon (C) to form stable MC-type primary carbides, and they have a strength-boosting function, especially for alloys which are not γ′-hardened.

Zirconium (Zr) and boron (B) are active for improving the high-temperature strength and ductility, through their grain boundary-active function, and at least one of them may be added to the alloy of the invention in an appropriate amount. Their effect is obtained at a low amount added.

Amounts of zirconium (Zr) and of boron (B) of more than 0.03 wt % and 0.014 wt %, respectively, lower the solidus temperature on heating, to the detriment of the hot formability.

Accordingly, the upper limits for zirconium (Zr) and boron (B) are 0.03 wt % and 0.014 wt %, respectively.

Nickel (Ni) forms a stable austenitic phase and becomes a matrix both for the solid solution and for the precipitation of the γ′ phase. Moreover, since nickel (Ni) is able to form a solid solution with a large amount of tungsten (W), an austenitic matrix is obtained which has a high strength at high temperatures, and nickel is therefore the balance of the alloy.

Apart from the elements described above, it is possible to add up to 12.5 wt % of cobalt (Co) to the alloy of the invention.

In the austenite of the matrix, cobalt (Co) exists in the solid solution state, thereby achieving a certain solid solution strengthening, and it also has an effect in improving the close adhesion of the oxide film. Given that cobalt (Co) in the Ni matrix is in the solid solution state and that cobalt (Co) has virtually no adverse effect on the precipitation of the γ′ phase, cobalt (Co) is favorable. However, since cobalt (Co) is an expensive element, the addition thereof in large amounts is not preferred.

The effect of these adaptations is to ensure processability for a productive L-PBF process with improved mechanical properties and increased oxidation resistance.

### DETAILED DESCRIPTION OF INVENTION

In accordance with the invention, therefore, the nickel-based alloy comprises, more particularly consists of (in wt %):
carbon (C): 0.11%-0.13%, more particularly 0.12%,
chromium (Cr): 9.7%-10.5%, more particularly 10.0%,
cobalt (Co): 10.5%-12.5%, more particularly 11.0% to 11.8%, very particularly 11.4%,
molybdenum (Mo): 2.8%-3.2%, more particularly 3.0%,
titanium (Ti): 3.3%-4.3%, more particularly 3.6%-4.0%, very particularly 3.8%,
aluminum (Al): 5.2%-5.8%, more particularly 5.5%,
hafnium (Hf): 1.3%-1.5%, more particularly 1.4%,
boron (B): 0.013%-0.014%,
zirconium (Zr): 0.015%-0.03%, more particularly 0.018%-0.022%, very particularly 0.02%,
tantalum (Ta): up to 0.05%,
niobium (Nb): up to 0.01%,
silicon (Si): up to 0.01%,
tungsten (W): up to 0.02%,
vanadium (V): up to 0.02%,
no rhenium (Re) and/or no ruthenium (Ru),
nickel, more particularly balance nickel (Ni)
residual impurities up to 0.1%.

The component is preferably a component of a turbine, more particularly of a gas turbine, and there more particularly in the “hot” region.

Examples (EX1, EX2, EX3) of a nickel-based alloy based on this concept are listed in the table below.

| | EX1 | EX2 | EX3 |
|---|---|---|---|
| C | 0.11 | 0.12 | 0.11 |
| Cr | 10.0 | 9.71 | 10.41 |
| Co | 11.1 | 11.6 | 11.4 |
| Mo | 2.10 | 3.0 | 3.15 |
| Ti | 3.43 | 3.8 | 4.11 |
| Al | 5.5 | 5.31 | 5.33 |
| B | 0.014 | 0.014 | 0.013 |
| Zr | 0.02 | 0.019 | 0.02 |
| Hf | 1.4 | 1.48 | 1.33 |

1. A nickel-based alloy, comprising (in wt %):
carbon (C): 0.11%-0.13%, more particularly 0.12%,
chromium (Cr): 9.7%-10.5%, more particularly 10.0%,
cobalt (Co): 10.5%-12.5%, more particularly 11.0% to 11.8%, very particularly 11.4%,
molybdenum (Mo): 2.8%-3.2%, more particularly 3.0%,
titanium (Ti): 3.3%-4.3%, more particularly 3.6%-4.0%, very particularly 3.8%,
aluminum (Al): 5.2%-5.8%, more particularly 5.5%,
hafnium (Hf): 1.3%-1.5%, more particularly 1.4%,
boron (B): 0.013%-0.014%, more particularly 0.014%,
zirconium (Zr): 0.015%-0.03%, more particularly 0.018%-0.022%, very particularly 0.02%,
tantalum (Ta): up to 0.05%,
niobium (Nb): up to 0.01%,
silicon (Si): up to 0.01%,
tungsten (W): up to 0.02%,
vanadium (V): up to 0.02%,
no rhenium (Re) and/or no ruthenium (Ru),
nickel, more particularly balance nickel (Ni)
residual impurities up to 0.1%.

2. A powder, comprising:
a nickel-based alloy which contains (in wt %):
carbon (C): 0.11%-0.13%, more particularly 0.12%,
chromium (Cr): 9.7%-10.5%, more particularly 10.0%,
cobalt (Co): 10.5%-12.5%, more particularly 11.0% to 11.8%, very particularly 11.4%,
molybdenum (Mo): 2.8%-3.2%, more particularly 3.0%,
titanium (Ti): 3.3%-4.3%, more particularly 3.6%-4.0%, very particularly 3.8%,
aluminum (Al): 5.2%-5.8%, more particularly 5.5%,
hafnium (Hf): 1.3%-1.5%, more particularly 1.4%,
boron (B): 0.013%-0.014%, more particularly 0.014%,
zirconium (Zr): 0.015%-0.03%, more particularly 0.018%-0.022%, very particularly 0.02%,
tantalum (Ta): up to 0.05%,
niobium (Nb): up to 0.01%,
silicon (Si): up to 0.01%,
tungsten (W): up to 0.02%,
vanadium (V): up to 0.02%,
no rhenium (Re) and/or no ruthenium (Ru),
nickel, more particularly balance nickel (Ni)
residual impurities up to 0.1%,
optionally
binders or refractory particles.

3. A process, comprising:
using an alloy based on nickel, more particularly for a casting process or a powder bed process,
wherein the alloy based on nickel is composed of (in wt %):
carbon (C): 0.11%-0.13%, more particularly 0.12%,
chromium (Cr): 9.7%-10.5%, more particularly 10.0%,
cobalt (Co): 10.5%-12.5%, more particularly 11.0% to 11.8%, very particularly 11.4%,
molybdenum (Mo): 2.8%-3.2%, more particularly 3.0%,
titanium (Ti): 3.3%-4.3%, more particularly 3.6%-4.0%, very particularly 3.8%,
aluminum (Al): 5.2%-5.8%, more particularly 5.5%,
hafnium (Hf): 1.3%-1.5%, more particularly 1.4%,
boron (B): 0.013%-0.014%, more particularly 0.014%,
zirconium (Zr): 0.015%-0.03%, more particularly 0.018%-0.022%, very particularly 0.02%,
tantalum (Ta): up to 0.05%,
niobium (Nb): up to 0.01%,
silicon (Si): up to 0.01%,
tungsten (W): up to 0.02%,
vanadium (V): up to 0.02%,
no rhenium (Re) and/or no ruthenium (Ru),
nickel, more particularly balance nickel (Ni)
residual impurities up to 0.1%.

4. A component, more particularly comprising a substrate, comprising:
a nickel-based alloy which is composed of (in wt %):
carbon (C): 0.11%-0.13%, more particularly 0.12%,
chromium (Cr): 9.7%-10.5%, more particularly 10.0%,
cobalt (Co): 10.5%-12.5%, more particularly 11.0% to 11.8%, very particularly 11.4%,
molybdenum (Mo): 2.8%-3.2%, more particularly 3.0%,
titanium (Ti): 3.3%-4.3%, more particularly 3.6%-4.0%, very particularly 3.8%,
aluminum (Al): 5.2%-5.8%, more particularly 5.5%,
hafnium (Hf): 1.3%-1.5%, more particularly 1.4%,
boron (B): 0.013%-0.014%, more particularly 0.014%,
zirconium (Zr): 0.015%-0.03%, more particularly 0.018%-0.022%, very particularly 0.02%,
tantalum (Ta): up to 0.05%,
niobium (Nb): up to 0.01%,
silicon (Si): up to 0.01%,
tungsten (W): up to 0.02%,
vanadium (V): up to 0.02%,
no rhenium (Re) and/or no ruthenium (Ru),
nickel, more particularly balance nickel (Ni)
residual impurities up to 0.1%
